(19) United States
(12) Patent Application Publication
(10) Pub. No.: US 2009/0305670 A1
(43) Pub. Date: Dec. 10, 2009

(54) SYSTEM AND METHOD FOR AUTOMATED KNOWLEDGE BASED AUTHENTICATION

(75) Inventors: Christopher R. DeBoer, Omaha, NE (US); Martin Franks, Springfield, NE (US)

Correspondence Address: HOLLAND & HART, LLP, P.O BOX 8749, DENVER, CO, 80201, US

(73) Assignee: Prairie Interactive Messaging, Omaha, NE (US)

(21) Appl. No.: 12/136,666

(22) Filed: Jun. 10, 2008

(51) Int. Cl. H04Q 7/20; G10L 17/00

(52) U.S. Cl. 455/411; 704/273; 704/E17.016

(57) ABSTRACT

Systems and methods of automatically authenticating identities are provided through an integration of interactive voice response technology with knowledge-based authentication methodology. An audible communications event is established between an individual and a computing device. Verification trigger data, relating to the individual, may be collected at the computing device. Identity verification questions are audibly presented to the individual, who provides audible responses, such as with speech or using DTMF tones. The responses may be scored according to a set of predetermined parameters whereby an authenticity of the identity is gauged. A client, who requests the identity authentication, may do so during a communication with the individual. Communication between the client and the individual may be reestablished after authentication using a whisper greeting.

### BACKGROUND

Commercial and personal business is frequently conducted over a wide array of communications networks and computer networks. Examples of such communications networks have included conventional telephone networks, cellular networks of different varieties, paging services, and the like. Computer networks frequently used to conduct such business include local area networks (LANs), wide area networks (WANs), metropolitan area networks (MANs), the Internet, and intranets. Businesses and individuals access these networks to communicate with one another, access data, and conduct transactional business. In these pursuits, it is often necessary, for security and other reasons, to confirm and/or verify an individual's identity before granting access to data or engaging in one or more transactions.

Passwords have become ubiquitous in commercial and personal business transactions. However, simple passwords provide only minimal levels of authentication. In fact, it has now become more common for passwords to be stolen or compromised, causing information intended only for the rightful owner of the password to frequently fall into the hands of thieves or unauthorized parties. Some industries, such as financial services, which include banks, brokerages, securities firms, insurance providers, etc., have historically verified an individual's identity by conducting business face-to-face, effectively avoiding password theft. However, electronic business transactions have become more prevalent through the use of identity management, tokens, biometrics, and digital signature technology, which are slightly more secure than the use of simple passwords. Unfortunately, as identity protection technology has improved, thieves have improved their methodologies to include phishing scams, bots, keystroke logging, and remote administrator tools.

Some identity protection methods have been developed but have been configured in manners that are industry-specific. For instance, some financial service providers have required users to make account-to-account fund transfers to validate the user. Equifax eID solutions, in another example, has required end users to have a thorough understanding of their financial and personal information. While such options may meet the needs of perspective target markets, they do not offer a solution that is easily transferred to all industries and markets.

Several non-password methodologies have been developed to authenticate individuals prior to authorizing transactions or permitting access to data. These systems have generally required a user to provide a sampling of basic identification information such as name, date of birth, social security number, address, telephone number, and/or driver's license information. Such information, known as “out of wallet” information, is compared to known data, such as a credit file, to determine how well the user's input matches that source. However, such data is easily stolen by thieves or may simply be known by third parties who know the intended user. Moreover, such systems may become repetitive in their questioning, allowing thieves to easily anticipate and prepare for the questions. Other systems employ speaker verification methods that compare modeled features of the individual's voice with previously obtained voice samples. While such systems are less easily avoided by unauthorized users, they can be expensive and require that a database of voice samples be maintained, and are subject to verification failures. Other identification systems, such as two factor identification, may use the combination of a password and a device such as a key FOB. However, key FOB devices are easily stolen along with password information. Moreover, it is all too easy for individuals to simply misplace the key FOB, effectively preventing their identification.

Knowledge-Based Authentication (KBA) processes and processors have been used since 2004 and in most early implementations, the questioning was done with a live operator or web interface. In such instances, however, the live agent never knew what a correct or incorrect answer was; the agent was simply asking the questions and soliciting responses. Other deficiencies have occurred using live agents to implement KBA processes. For example, there are high hiring and operational costs associated with live personnel that, in turn, typically demonstrate high turn-over rates. Commonly, poor quality of service is experienced across live agent pools. More concerning, however, is the fact that live personnel tend to demonstrate poor adherence to standard security protocols regarding the manner in which the KBA process is administered.

Several electronic KBA schemes have been developed, but also proved deficient. For instance, users who have provided accurate identification information in some systems have not been authenticated, for example, because the user entered a nickname rather than a given name. Common electronic authentication processes do not check for variations to the correct answer. As a result, a user who should be entitled to access information or perform a transaction cannot do so. Other inconsistencies caused by the system or various user responses have triggered false negatives. Such false negatives have terminated the transaction with the user without further processing or corrective querying. In other instances, users who have supplied fraudulent information have been authenticated. This has often occurred when lost or stolen wallet-type information is entered by unauthorized users.

Traditional Interactive Voice Response (IVR) systems have been used in various industries to accept or send inbound and outbound voice calls. Such IVR systems have relied on pre-recorded questions to accept or validate the caller or called party's name as a means of verifying the party's identity. This traditional method has been subject to fraudulent activity as there has been no automated, reliable, and cost efficient means of validating the true identity of the party.

### SUMMARY

This Summary is provided to introduce a simplified selection of some concepts that are further described below in the Detailed Description. This Summary and the Background are not intended to identify key aspects or essential aspects of the claimed subject matter. Moreover, this Summary is not intended for use as an aid in determining the scope of the claimed subject matter.

Systems and methods of automatically authenticating the identities of individuals are presented in which a communications event may be established over a network between an individual using a communications device and a computing device. In some embodiments, at least one interactive voice response program is associated with the computing device that is operative to enable the computing device to communicate with the individual and remote computing devices, communications devices, and databases. Accordingly, in such embodiments, the individual may communicate with the computing device in an audible manner, such as with speech or using DTMF tones.

Verification trigger data, relating to the individual, may be collected at the computing device. In some embodiments, the verification trigger data is collected by cross-referencing a telephone number associated with the individual's communications device with one or more information databases during the communications event between the individual and the computing device. The computing device audibly presents one or more identity verification questions, such as by speech. The individual may then present audible responses to the computing device. The responses may be scored according to a set of predetermined parameters whereby an authenticity of the identity is gauged.

In various embodiments, a client, associated with the individual, requests authentication of said individual's identity. The request may be in the form of an automated protocol or in response to a triggering event. In some embodiments, a live representative of the client may initiate the authentication process in response to aspects of a communication between the representative and the individual. After completing an authentication process, the communication between the representative and the individual may be reestablished.

In some aspects, the client may specify the quantity and/or difficulty of the identity verification questions prior to requesting authentication of said individual's identity. In other aspects, at least one data source provides facts that relate to correct answers to the identity verification questions. The data source may include a wide array of private and or public databases.

Aspects of the present system and method replace live agent handling of identity authentication while providing a level of consistency and tracking that would be impossible to replicate cost effectively in a normal live agent configuration. The integration of knowledge-based authentication and interactive voice response technologies allow for a more secure and cost efficient method of identity verification. Closed end and multiple choice questions can be presented to the individual and the use of speech recognition technologies can translate the party's response back into data based information for verification with a knowledge-based authentication engine. Advanced analytics can tailor the questions based on frequency of use and transaction type. Use of the present technology eliminates agent-based phishing and repeated calling for the purpose of “question mapping”. This additional functionality provides value to the business in two ways by reducing costs and increasing process security.

These and other aspects of the present system and method will be apparent after consideration of the Detailed Description and Figures herein. It is to be understood, however, that the scope of the invention shall be determined by the claims as issued and not by whether given subject matter addresses any or all issues noted in the Background or includes any features or aspects recited in this Summary.

### DRAWINGS

Non-limiting and non-exhaustive embodiments of the present invention, including the preferred embodiment, are described with reference to the following figures, wherein like reference numerals refer to like parts throughout the various views unless otherwise specified.

FIG. 1 depicts a general system schematic of a computer device that may be used with the automated knowledge based authentication system.

FIG. 2 depicts a general system schematic of one embodiment of the automated knowledge based authentication system.

FIG. 3 depicts another general system schematic of one embodiment of the automated knowledge based authentication system.

FIG. 4 depicts a general process diagram of one embodiment of a method for automatically authenticating identities.

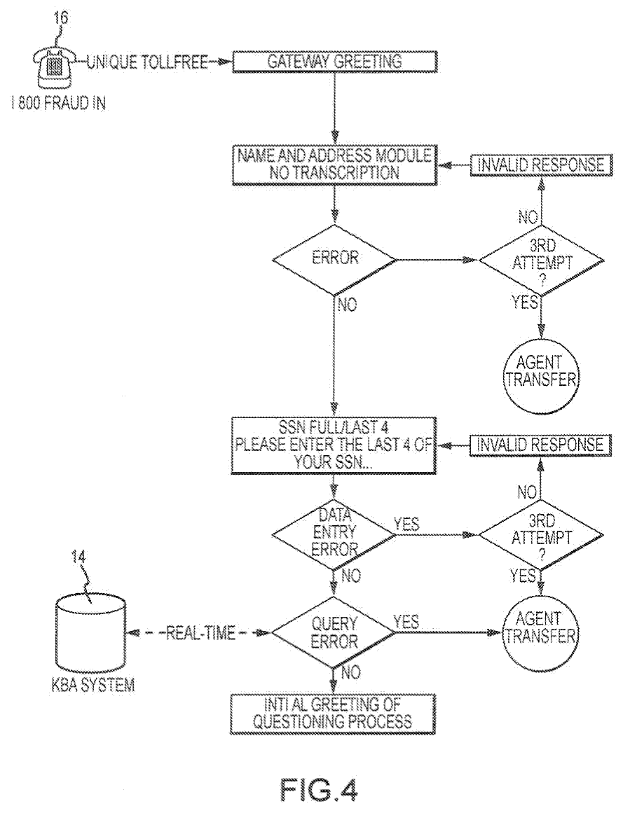

FIG. 5 depicts a data flow diagram of one embodiment of a method for automatically authenticating identities.

FIG. 6 depicts a call flow diagram of one embodiment of a method for automatically authenticating identities.

FIG. 7 depicts a flow diagram of one embodiment of a call transfer process that may be implemented with one or more embodiments of the methods for automatically authenticating identities.

### DETAILED DESCRIPTION

Embodiments are described more fully below with reference to the accompanying figures, which form a part hereof and show by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense.

Various embodiments of a system and methods for automatically authenticating identities are presented that enable clients, in need of authenticating their customers' identities, to replace live agent handling of identity authentication while providing enhanced levels of consistency and tracking. In many embodiments, the integration of knowledge-based authentication (KBA) and interactive voice response (IVR) technologies allow for secure, efficient, and cost-effective methods of identity verification. Closed end and multiple choice identity verification questions may be presented to individuals. In some embodiments, speech recognition technologies are then used to translate the individuals' responses back into data based information for verification with a knowledge-based authentication engine. Advanced analytics can tailor the identity verification questions based on frequency of use and transaction type. In some embodiments, the present technology may serve as a gateway for engaging clients and third party knowledge-based authentication providers in an automated process. In other embodiments, the technology may be implemented in a full transactional solution with knowledge-based authentication.

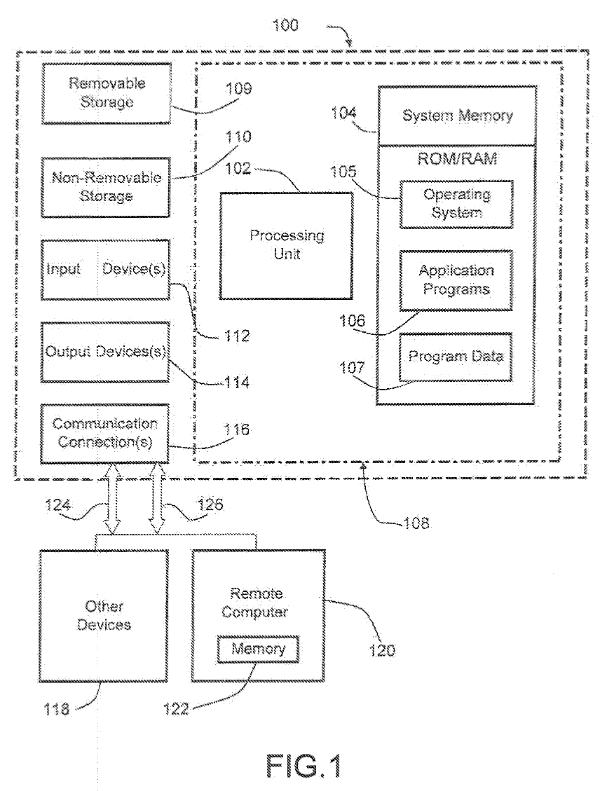

With reference to FIG. 1, an example of a suitable computing system environment is illustrated in the form of a computing device 100 on which one or more various embodiments of the automated, knowledge-based authentication system 10 may be at least partially implemented. The computing device 100 is only one example of a suitable computing environment and is not intended to suggest any limitation as to the scope of use or functionality of the present system. The system 10 can also be run on other general purpose or special purpose computing system environments or configurations. Examples of well known computing systems, environments, and/or configurations that may be utilized include, but are not limited to, personal computers, server computers, network PCs, minicomputers, mainframe computers, distributed computing environments that include any of the above systems or devices, and the like.

The system 10 may be described in the general context of computer-executable instructions, such as program modules, being executed by a computing device. Generally, program modules include routines, programs, objects, components, data structures, etc. that perform particular tasks or implement particular abstract data types. The system may also be practiced in distributed computing environments in which tasks are performed by remote processing devices that are linked through a communications network. In a distributed computing environment, program modules may be located in both local and remote computer storage media, including memory storage devices.

Referring to FIG. 1, an exemplary system includes a computing device, such as computing device 100. In a basic configuration, computing device 100 typically includes at least one processing unit 102 and system memory 104. Depending on the exact configuration and type of computing device, system memory 104 may be volatile (such as RAM), non-volatile (such as ROM, flash memory, and the like) or some combination of the two. System memory 104 typically includes operating system 105, one or more application programs 106, and may include program data 107. Examples of application programs 106 include interactive voice response (IVR) programs, phone dialer programs, dual-tone multi-frequency (DTMF) recognition programs, speech recognition programs, text-to-speech programs, e-mail programs, external interface programs, scheduling programs, PIM (personal information management) programs, database programs, word processing programs, spreadsheet programs, Internet browser programs, and so forth. This basic configuration is illustrated in FIG. 1 by those components within dashed line 108.

Computing device 100 may also have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and non-volatile, removable and non-removable media implemented in any method or technology for storage of information, such as computer readable instructions, data structures, program modules or other data. System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as a keyboard, mouse, pen, voice input device, touch input device, etc. Output device(s) 114 such as a display, speakers, printer, etc. may also be included. All these devices are known in the art aid need not be discussed at length here.

Computing device 100 also contains communication capability 116 that allows the device to communicate with other devices 118 (such as printing devices, stand alone e-mail servers, facsimile devices, and the like), such as over a network or a wireless mesh network. Communication media can be transmitted through the communication capability 116 and can include computer readable instructions, data structures, program modules or other data in a modulated data signal such as a carrier wave or other transport mechanism.

The term “modulated data signal” means a signal that has one or more of its characteristics set or changed in such a manner as to encode information in the signal. By way of example, and not limitation, communication media includes wired media, such as a wired network or direct-wired connection, and wireless media such as acoustic, RF, infrared, or other wireless media. The term computer readable media, as used herein, includes both storage media and communication media.

The computing device 100 may operate in a networked environment using logical connections to one or more remote computers, such as a remote computer 120. The remote computer 120 may be operated by a client, consumer or third-party service provider (including one or more providers of various information databases, research tools, reporting services, and the like); may take the form of a personal computer, a server, a router, a network PC, PDA, a peer device, or other common network node; and typically includes many or all of the elements described above relative to the computing device 100. It is further contemplated, however, that the remote computer 120 could be provided in the form of a telephone, which includes cellular telephones, landline telephones and the like. The logical connections, depicted in FIG. 1, include a local area network (LAN) 124 and a wide area network (WAN) 126, but may also include other proprietary and non-proprietary networks 128, such as wireless networks, a PSTN, the Internet, an intranet, extranet, and the like. It will be appreciated, however, that the network connections shown are exemplary and other networking and communications means may be used. FIG. 1 illustrates an example of a suitable system environment on which the present technology may be implemented.

In some embodiments the computing device 100 may be configured to serve as a telephony server. In such embodiments, the computing device 100 may be coupled with networks 128 that may include one or more of the PSTN, VoIP network, TCP/IP network, or the like. The computing device may be configured to operate as an interpreter, Or gateway, so incoming communications can interface with interactive voice response (IVR) programs and access information on one or more local or remotely situated databases containing real-time information that can be accessed by the IVR programs. In various embodiments, one or more databases may be linked to the computing device 100 over the TCP/IP network. One or more different applications may be associated with the computing device 100 that include: customer service applications, outbound calling applications, voice-to-text transcription applications, and the like. Some or all of these applications may be provided in VXML. As such, the computing device 100 may also contain one or more programs that control functions like text-to-speech, voice recognition and DTMF recognition.

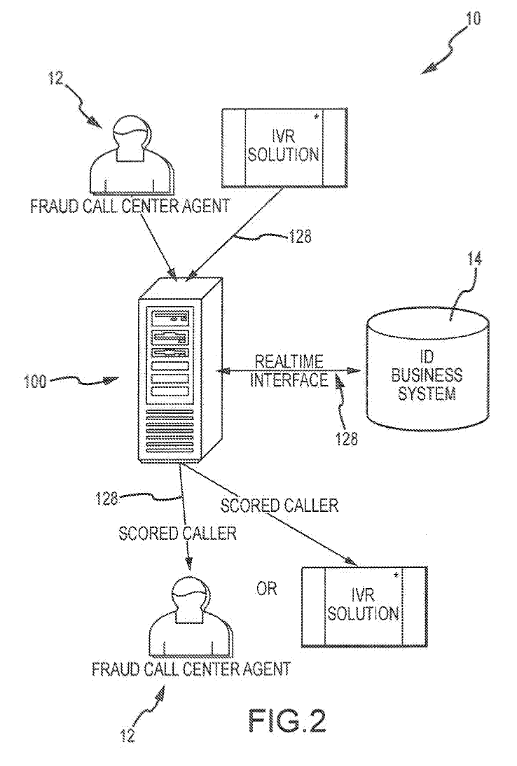

With reference to FIG. 2, a general system schematic is depicted of one embodiment of the system 10. In general terms, the system 10 includes a client system 12, which may be operated by an automated or live call center agent. The client system 12, in various embodiments, may also include a client or third-party hosted IVR solution. In some embodiments, the client system 12 may include one or more computing systems, environments, and/or configurations that could include one or more of: server computers; network PCs; minicomputers; mainframe computers; personal computers, and the like. In other embodiments, the client system 12 may include a telephone, cell phone, wireless computing device, or similar communications device that is capable of accessing at least one network, such as a wireless network, PSTN, VOIP, the Internet, an intranet, extranet, and the like. It will be appreciated, however, that the client system 12 and the networks described are exemplary and other devices and networks may be used. The client system 12, in most respects, will be configured to selectively transmit and receive data streams. These data streams may be in the form of voice, text, or other such transmissions. A connection over network 128 may be provided to enable the exchange of data streams between the client system 12 and the computing device 100.

In various embodiments, an identification system 14 may be associated with the system 10. It is contemplated that the ID system 14 may be a related component of the computing device 100, located on site with the computing device 100 or located remotely therefrom. The identification system 14 may be proprietary to the system 10 or provided by a third party vendor. In some embodiments, the identification system 14 may be provided in the form of one or more server computers, network PCs, minicomputers, mainframe computers, personal computers, and the like. Irrespective of the form in which the identification system 14 is provided, it should be capable of accessing at least one network, such as a private network, the Internet, an intranet, extranet and the like. Such network connectability should be provided to enable the receipt in transmission of data streams between the ID system 14 and the computing device 100 as well as other public, private, and governmental databases.

In various embodiments, the identification system 14 will be provided with a knowledge-based authentication engine that is configured to receive data based information and use that information to scan a plurality of private and/or public record databases to obtain unique, identity related facts specific to particular individuals or entities. In some embodiments, the data based information may include verification trigger data, such as an individual or entity's name, address, telephone number, full or partial social security numbers, and the like. In some embodiments, the private, public or government databases may include one or more of the following: a credit reporting database; a small business information service database; Dunn & Bradstreet; postal databases; register of deeds database, county assessor database, a driver's license bureau database; a phone number database; an investment account database; an insurance carrier database; a governmental information database, a utility company information database; an automobile registration database, or databases internal to a client, or a client system 12.

In various embodiments, the identification system 14 will use the facts obtained from the various private, public and government databases to derive a series of top of mind identity verification questions that vary in their scope, complexity, and degree to which only a specific individual or entity would know the answer. Where the identity to be authenticated is for an individual, the questions may relate to: the individual's age; various aspects of the individual's current or prior residential addresses; the identities of current or previous employers of the individual; the identities of one or more organizations to which the individual belonged; the identity, age, residential addresses, occupations, and the like of third parties who are related to or associated with the individual; detailed descriptions of automobiles, or other property, currently or previously owned or maintained by the individual; and other such personal identification related matters. In many embodiments, the identity verification questions will be designed to logically develop correct and incorrect answers using the data obtained. In some respects, the identity verification questions may be presented to have multiple choice answers which may be responded to using speech or DTMF tones. In other embodiments, the responses may be provided in an open ended fashion whereby the responses could also be provided using speech or DTMF tones. In some aspects, the knowledge-based authentication engine will be provided with one or more application programs capable of receiving responses to the identity verification questions and determining the accuracy of those responses. One or more various forms of memory may be associated with the identification system 14 to at least temporarily record and track the responses through one or more different questioning sessions. In this manner, the responses may be scored. In some embodiments, the scoring of the responses may be provided by asking a certain number of questions and determining a ratio of correct to incorrect responses provided. In some aspects, some identity verification questions may be pre-assigned with a greater weight or value in relation to other identify verification questions presented. In this manner, the scoring may be provided to reflect different degrees of overall responses in an attempt to weed out fraudulent responses. It is anticipated that such application programs related to the receipt of responses and the scoring of the same may be directly associated with the computing device 100, rather than the identification system 14, where such an arrangement is desirable.

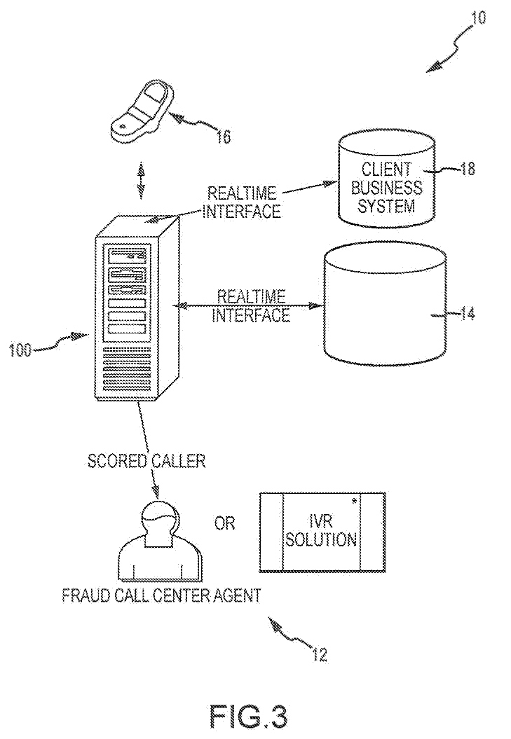

With reference to FIG. 3, the verification trigger data may be collected at the computing device 100 in a number of different manners. In some embodiments, where an individual contacts the computing device 100 using a phone 16, such as a telephone, cell phone, or other such wireless device over a network 128, a telephone number for the phone may be detected. Once the phone number has been captured, one or more application programs 106 may be provided to relate the phone number to one or more private or public databases (either locally or remotely located) to obtain precise name and address information relating to the individual's phone 16. In other embodiments, where contact information for the individual has been previously provided to the computing device 2100, the computing device 100 may contact the individual's phone over a network 128. The computing device may use the contact information to obtain specific information on the individual much in the same manner as it would where the individual's phone number is captured on an in-bound call. In some instances, the application programs 106 may be directly associated with the computing device 100 or may be made available through an application service provider (ASP). In either respect, identity databases may be searched over a network 128 in a manner that provides a real time interface. In other embodiments, the verification trigger data may be provided to the computing device 100 by a client business system 18. In such instances, the verification trigger data may be assembled by the client business system 18 through public databases or through proprietary records assembled through one or more business relationships between the individual and the client. A real time interface may be maintained on a network 128 between the computing device 100 and the client business system 18 in order to provide a seamless transition of information during one or more authentication processes.

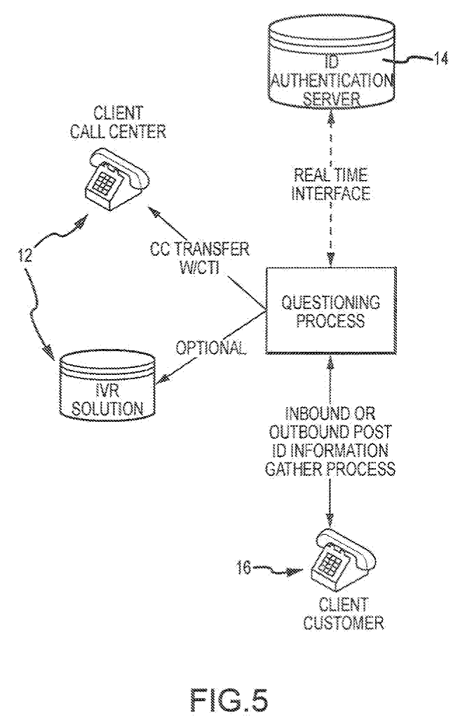

The system 10 is subject to various methods of use and different embodiments of implementation. In one aspect, the system 10 may be provided to receive inbound calls from an individual's phone 16. In at least one embodiment, the network 128 between the individual's phone 16 and the computing device 100 may be a PSTN or VOIP, whereby the individual uses a unique toll free number to dial into the computing device 100. Once the communication event is established between the individual and the computing device 100, a gateway greeting may be provided by the computing device 100. Simultaneously, through a local application program 106 or a third party provider, verification trigger data relative to a phone number associated with the individual's phone 16 may be obtained. In some embodiments, the application program 106 will be a name and address module, such as one of various such modules employed within the industry currently. The computing device 100 may then be provided to review the receipt of the verification trigger data to determine whether or not an error occurred during the receipt of such data. A continuing loop to pass the captured phone number through the name and address module may be implemented in order to verify that complete and accurate verification trigger data has been obtained. In some instances, the loop through the name and address module may be stopped at any number of attempts, such as a three attempt loop, whereby after a third failure, the individual's call may be transferred to an agent or IVR solution associated with the client system 12. In such instances, a whisper greet transfer may be made whereby contact is first established between the computing device 100 and the client system 12 and information relative to the call is passed on an open line to the client system 12 without the pass of such information being audibly perceived by the individual. In some embodiments, the individual may be directed to speak or input through keystrokes on the individual's phone 16 a full or partial account or user identifiable number. Other data, such as account numbers and the like, may be used in place of the full or partial social security number. A data entry error loop may be provided to guarantee the receipt of a complete response from the individual. After a certain number of failed attempts and no information, or incomplete information, is received by the computing device 100, the individual's call may be transferred to the client system 12. However, where complete information is obtained, a collection of verification trigger data may be passed, real time, to a locally positioned or remotely located identification system 14. In various embodiments, the identification system 14 will then use the verification trigger data to obtain additional identification data in the manner previously described herein and formulate a plurality of identity verification questions. These identity verification questions may then be passed to the computing device 100 and the individual may be presented with an initial greeting of the questioning process. With reference to FIG. 5, an exemplary embodiment of a high level data flow is depicted that demonstrates the exchange of data throughout the aforedescribed process.

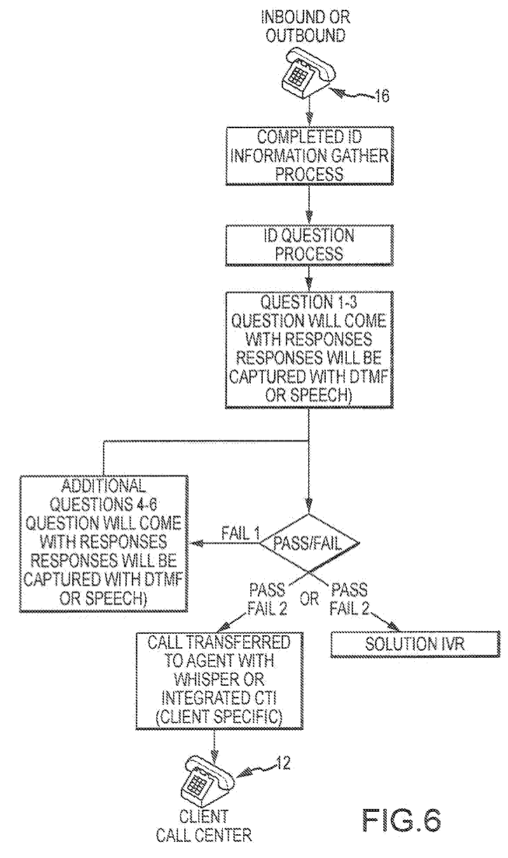

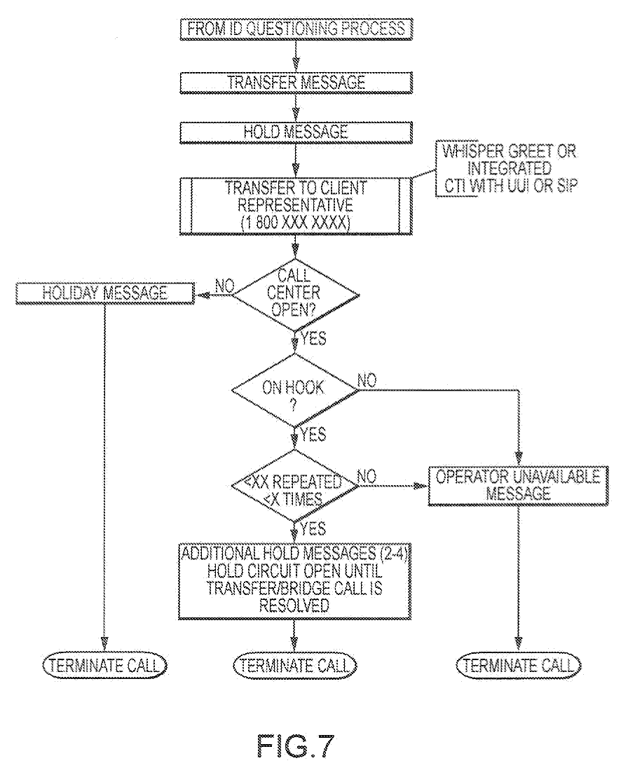

With reference to FIG. 6, an example of one manner in which the call flow may continue between the individual and the computing device 100 is provided. During the identification question process, one or more identity verification questions are audibly presented from the computing device 100 to the individual over a network 128. The individual response to the identity verification questions audibly, either in DTMF tones or speech, depending upon the format of the identity verification questions. The individual's responses may then be scored according to a set of predetermined parameters to gauge the authenticity of the individual's purported identity. In some embodiments, a client may determine the number of questions to be asked, the type of questions to be asked, and/or the complexity and difficulty of the questions to be asked. Moreover, the client may provide a threshold score, such as three of four correctly answered identity verification questions, in order to determine whether or not the individual's identity has been authenticated. Accordingly in various embodiments, where a first failure is determined after the responses have been scored, additional questions may be presented to the individual for a second round of verification. In some instances, after a second fail or a pass is determined by the scoring step, the individual may be transferred to the client system 12 to address the issue of a failed identity authentication or continue about the individual's business with the client. In other instances, the individual may be passed to an IVR solution associated with the client, that may be hosted by the client system 12, the computing device 100, or other ASP. With reference to FIG. 7, the continuation of the communications events between the individual and the computing device 100 and the client system 12, is shown in an exemplary embodiment. On completion of the identity questioning process, a message may be presented to the individual that explains that the individual will be transferred. A hold message may then be presented to the individual prior to initiating the transfer to the client system 12. In some instances, this transfer may be performed according to the previously described whisper greet protocol. When the computing device 100 attempts to make the transfer, it is contemplated that the client system 12 may not be available. For example, where the client system 12 is closed for the day or due to a holiday, an appropriate message may be provided to the individual and the communications between the individual and the computing device 100 may be terminated. Where it is determined that the client system 12 is busy, such as the example of the line being on the hook, the computing device 100 may be provided to repeat its attempt to establish contact between the individual and the client system 12 a predetermined number of times. Additional messages may be passed from the computing device 100 to the individual, explaining that an additional hold will be necessary while the computing device 100 attempts to transfer, or bridge the call, to the client system 12. Where it is determined that the client system 12 is not available after the predetermined number of times, a message may be presented to the individual explaining that the client system 12 is currently unavailable. The communications between the computing device 100 and the individual may be terminated at that time.

Although the system 10 has been described in language that is specific to certain structures, devices, and methodological steps, it is to be understood that the invention defined in the appended claims is not necessarily limited to the specific structures, materials, and/or steps described. Rather, the specific aspects and steps are described as forms of implementing the claimed invention. Since many embodiments of the invention can be practiced without departing from the spirit and scope of the invention, the invention resides in the claims hereinafter appended. Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques. Moreover, all ranges disclosed herein are to be understood to encompass and provide support for claims that recite any and all subranges or any and all individual values subsumed therein. For example, a stated range of 1 to 10 should be considered to include and provide support for claims that recite any and all subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g. 3, 5.8, 9.9994, and so forth).

What is claimed is:

1. A method of automatically authenticating an identity of an individual, the method comprising:
(a) establishing a communications event over a network between (i) an individual using a communications device and (ii) a computing device; whereby said individual communicates with said computing device in an audible manner;
(b) collecting verification trigger data, relating to the individual, at said computing device;
(c) audibly presenting one or more identity verification questions from said computing device to said individual over said network;
(d) audibly presenting responses to said identity verification questions from said individual to said computing device over said network; and
(e) scoring said responses according to a set of predetermined parameters whereby an identity for said individual is gauged.

2. The method of claim 1 wherein:
said individual at least partially communicates with said computing device using audible speech.

3. The method of claim 1 wherein:
said communications device is a phone; and
said network is one of a PSTN, VOIP or wireless network.

4. The method of claim 3 wherein:
said individual at least partially communicates with said computing device using audible DTMF tones.

5. The method of claim 1 wherein:
at least one interactive voice response program is associated with said computing device; and
said at least one interactive voice response program is operative on computing device to enable said computing device to communicate with said individual.

6. The method of claim 1 wherein:
a client has requested authentication of said individual's identity prior to the step of establishing the communications event between said individual and said computing device.

7. The method of claim 6 wherein:
said client and said individual are engaged in a communications event prior to said client requesting said authentication of said individual's identity.

8. The method of claim 1 wherein:
a live representative of a client requests authentication of said individual's identity and causes said communications event to be established.

9. The method of claim 8 wherein:
said live representative of said client and said individual are engaged in a communications event prior to said live representative requesting said authentication of said individual's identity.

10. The method of claim 9 further comprising:
transmitting the scoring of said responses from said computing device to said client over a network.

11. The method of claim 10 further comprising:
reestablishing the communications event between said live representative and said individual after the step of transmitting the scoring of said responses from said computing device to said client.

12. The method of claim 1 further comprising:
transmitting the scoring of said responses from said computing device to a client over a network.

13. The method of claim 1 wherein:
said verification trigger data is transmitted to said computing device by the individual during the communications event between said individual and said computing device.

14. The method of claim 1 wherein:
said verification trigger data is transmitted to said computing device by a client, who has requested authentication of said individual's identity, prior to the step of establishing the communications event between said individual and said computing device.

15. The method of claim 1 wherein:
said verification trigger data is transmitted to said computing device by a third party vendor during the communications event between said individual and said computing device.

16. The method of claim 1 wherein:
said verification trigger data is collected by cross-referencing a data element associated with the individual with one or more information databases during the communications event between said individual and said computing device.

17. The method of claim 1 further comprising:
establishing a communications event between said individual and a client, who has requested authentication of said individual's identity, after the step of scoring said responses.

18. The method of claim 6 wherein:
the client has specified a number of said identity verification questions prior to requesting authentication of said individual's identity.

19. The method of claim 18 wherein:
said client has specified a level of difficulty of said identity verification questions prior to requesting authentication of said individual's identity.

20. The method of claim 1 wherein:
at least one data source provides facts that relate to correct answers to said identity verification questions.

21. The method of claim 20 wherein:
said at least one data source comprises one or more of: a credit reporting database; a small business information service database; Dunn & Bradstreet; postal databases; a driver's license bureau database; a phone number database; an investment account database; an insurance carrier database; a governmental information database; a utility company information database; an automobile registration database; or databases internal to a client who has requested authentication of said individual's identity.

22. The method of claim 1 wherein the computing device is operative over multiple channels that include one or more of the Internet, an intranet, e-mail, phone systems, SMS.

23. A method of authenticating an identity of an individual associated with a client who has requested authentication of the individual's identity, the method comprising:
(a) providing a computing device that includes at least one interactive voice response program that enables said computing device to receive and transmit audible communications over at least one network;
(b) establishing a communications event over a network between the individual and said computing device; whereby said individual communicates with said computing device using speech and/or DTMF tones;
(c) collecting verification trigger data, relating to the individual, at said computing device;
(d) presenting one or more identity verification questions from said computing device to said individual as speech over said network;
(e) presenting speech and/or DTMF tone responses to said identity verification questions from said individual to said computing device over said network; and
(f) scoring said responses according to a set of predetermined parameters whereby an authenticity of the identity of the individual is determined.

24. The method of claim 23 wherein:
the client has requested authentication of the individual's identity prior to the step of establishing the communications event between the individual and said computing device; and
a representative of the client and the individual are engaged in a communications event prior to the client requesting said authentication of the individual's identity.

25. The method of claim 24 further comprising:
transmitting the scoring of said responses from said computing device to the client over a network.

26. The method of claim 25 further comprising:
reestablishing the communications event between the client and the individual after the step of transmitting the scoring of said responses from said computing device to the client.

27. The method of claim 23 wherein:
said verification trigger data is collected by cross-referencing a telephone number associated with said individual's communications device with one or more information databases during the communications event between said individual and said computing device.
